(19) United States
(12) Patent Application Publication
(10) Pub. No.: US 2025/0271739 A1
(43) Pub. Date: Aug. 28, 2025

(54) LIGHT SOURCE APPARATUS AND PROJECTOR

(71) Applicant: SEIKO EPSON CORPORATION, Tokyo (JP)

(72) Inventors: Ryota TAKAI, MATSUMOTO-SHI (JP); Shingo KOMIYAMA, CHINO-SHI (JP); Takumi NAGAI, TOMIOKA-SHI (JP)

(21) Appl. No.: 19/058,497

(22) Filed: Feb. 20, 2025

(30) Foreign Application Priority Data
Feb. 22, 2024 (JP) 2024-025308

(51) Int. Cl. G03B 21/20; G03B 21/16

(52) U.S. Cl. CPC G03B 21/204; G03B 21/16; G03B 21/2013

(57) ABSTRACT

A light source apparatus includes a light emitter configured to emit first light having a first wavelength band; and a wavelength converter containing a phosphor and configured to convert the first light into second light having a second wavelength band different from the first wavelength band and output the second light, the wavelength converter having a first surface on which the first light is incident, a second surface facing a side opposite the first surface, and a third surface which intersects with both the first and second surfaces and via which the second light exits, and a density of fluorescence emission points of the phosphor increasing along a direction from the first surface toward the second surface.

The present application is based on, and claims priority from JP Application Serial Number 2024-025308, filed Feb. 22, 2024, the disclosure of which is hereby incorporated by reference herein in its entirety.

### BACKGROUND

### 1. Technical Field

The present disclosure relates to a light source apparatus and a projector.

### 2. Related Art

As a light source apparatus used in a projector, there has been a proposed light source apparatus that outputs fluorescence emitted from a phosphor when the phosphor is irradiated with excitation light emitted from a light emitter. JP-A-2023-108325 discloses a light source apparatus including a light source element that outputs excitation light and a wavelength converting member containing a phosphor that converts the excitation light into fluorescence.

JP-A-2023-108325 is an example of the related art.

In the technology described in JP-A-2023-108325, the density of fluorescence emission points of the phosphor contained in the wavelength converting member is uniform across the entire wavelength converting member. Therefore, out of the multiple outer surfaces of the wavelength converting member, a portion of the phosphor that is closer to the light incident surface on which the excitation light is incident absorbs a greater amount of the excitation light. Accordingly, when the temperature of a portion of the wavelength converting member that is close to the light incident surface becomes too high, there is a concern about an increase in the amount of thermal quenching of the fluorescence in the portion of the wavelength converting member that is close to the light incident surface. There is therefore a concern about a decrease in the wavelength conversion efficiency, which is the efficiency at which the wavelength converting member converts the excitation light into the fluorescence.

### SUMMARY

A light source apparatus according to an aspect of the present disclosure includes a light emitter configured to emit first light having a first wavelength band; and a wavelength converter containing a phosphor and configured to convert the first light into second light having a second wavelength band different from the first wavelength band and output the second light, the wavelength converter having a first surface on which the first light is incident, a second surface facing a side opposite the first surface, and a third surface which intersects with both the first and second surfaces and via which the second light exits, and a density of fluorescence emission points of the phosphor increasing along a direction from the first surface toward the second surface.

A projector according to another aspect of the present disclosure includes the light source apparatus described above; a light modulator configured to modulate light containing the second light output from the light source apparatus; and a projection optical apparatus configured to project the light modulated by the light modulator.

### BRIEF DESCRIPTION OF THE DRAWINGS

FIG. 1 is a schematic configuration diagram of a projector according to a first embodiment.

FIG. 2 is a schematic configuration diagram of a first Illuminator in the first embodiment.

FIG. 3 is a cross-sectional view of a light source apparatus taken along the line III-III in FIG. 2.

FIG. 4 shows the distribution of the density of fluorescence emission points of a wavelength converter in the first embodiment in a light incident direction.

FIG. 5 shows the distribution of the intensity of first light in the wavelength converter in the first embodiment in the light incident direction.

FIG. 6 shows the distribution of the amount of heat generated by the wavelength converter in the first embodiment in the light incident direction.

FIG. 7 is a schematic configuration diagram of a first Illuminator in a second embodiment.

FIG. 8 shows the distribution of the density of fluorescence emission points of a wavelength converter in the second embodiment in a light incident direction.

### DESCRIPTION OF EMBODIMENTS

Embodiments of the present disclosure will be described with reference to the drawings. In the drawings to which the following description refers, each layer or each member may be shown at a different scale for clarity of the layer or the member.

The following description with reference to the drawings will be made by using an XYZ orthogonal coordinate systemin as required. The Z-axis is an axis along the vertical direction of a projector. The X-axis is an axis parallel to a first optical axis J1, which is the optical axis of a first Illuminator. The Y-axis is an axis perpendicular to both the X-axis and the Z-axis.

### First Embodiment

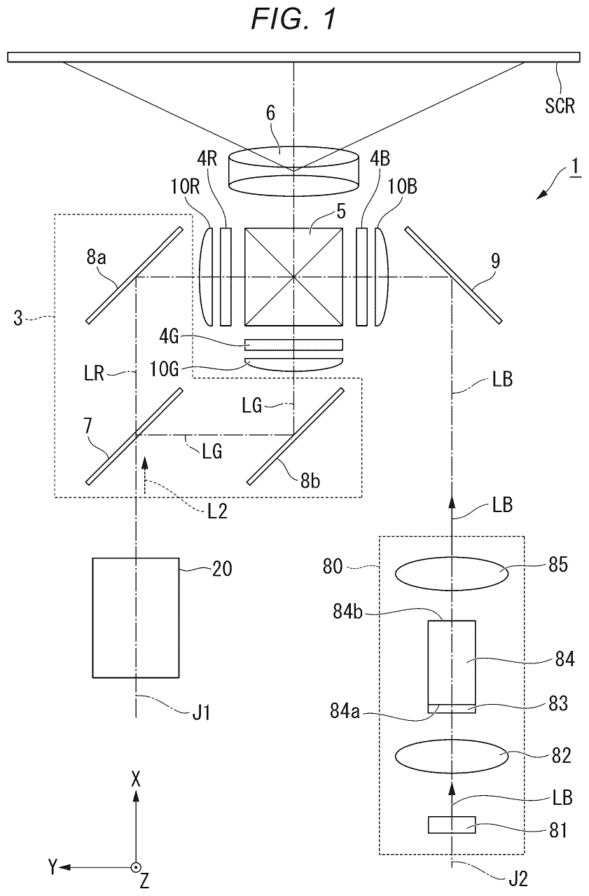

A first embodiment of the present disclosure will be described below with reference to the drawings. FIG. 1 shows a schematic configuration of a projector 1 according to the present embodiment. The projector 1 according to the present embodiment is an example of a projector using liquid crystal panels as light modulators. The projector 1 is a projection-type image display apparatus that displays a color image on a screen SCR, which is a projection receiving surface, as shown in FIG. 1. The projector 1 includes three light modulators 4R, 4G, and 4B corresponding to three types of color light, red light LR, green light LG, and blue light LB. The projector 1 includes a first illuminator 20, a second illuminator 80, a color separation system 3, the light modulators 4R, 4G, and 4B, a light combiner 5, and a projection optical apparatus 6.

The first Illuminator 20 outputs yellow second light L2 toward the color separation system 3. The second Illuminator 80 outputs the blue light LB toward the light modulator 4B. Detailed configurations of first Illuminator 20 and the second Illuminator 80 will be described later.

The color separation system 3 separates the yellow second light L2 output from the first Illuminator 20 into the red light LR and the green light LG. The color separation system 3 includes a dichroic mirror 7, a first reflection mirror 8a, and a second reflection mirror 8b.

The dichroic mirror 7 separates the second light L2 into the red light LR and the green light LG. The dichroic mirror 7 transmits the red light LR and reflects the green light LG. The second reflection mirror 8b is disposed in the optical path of the green light LG. The second reflection mirror 8b reflects the green light LG, which has been reflected off the dichroic mirror 7, toward the light modulator 4G. The first reflection mirror 8a is disposed in the optical path of the red light LR. The first reflection mirror 8a reflects the red light LR, which has passed through the dichroic mirror 7, toward the light modulator 4R.

The blue light LB B output from the second Illuminator 80 is reflected off a reflection mirror 9 toward the light modulator 4B. The second illuminator 80 includes a second light source section 81, a light collecting lens 82, a diffuser plate 83, a rod lens 84, and a relay lens 85. The second light source section 81 is configured with at least one semiconductor laser. The second light source section 81 outputs the blue light LB, which is laser light, toward the light collecting lens 82. Note that the second light source section 81 is not limited to a semiconductor laser and may be configured with a light emitting diode (LED) that emits blue light.

The light collecting lens 82 is configured with a convex lens. The light collecting lens 82 causes the blue light LB output from the second light source section 81 to enter the diffuser plate 83 with the blue light LB collected at the diffuser plate 83. The diffuser plate 83 diffuses the blue light LB output from the light collecting lens 82 with a predetermined diffusion degree to generate blue light LB having a uniform light orientation distribution. The diffuser plate 83 is configured, for example, with a ground glass made of optical glass.

The blue light LB diffused by the diffuser plate 83 enters the rod lens 84. The rod lens 84 has a prismatic shape extending along a second optical axis J2. The rod lens 84 has a light incident end surface 84a provided at one end and a light exiting end surface 84b provided at the other end. The diffuser plate 83 is fixed to the light incident end surface 84a of the rod lens 84 with an optical adhesive (not shown). It is desirable that the refractive index of the diffuser plate 83 is as close as possible to the refractive index of the rod lens 84. Note that the second optical axis J2 is the center axis of the blue light LB output from the second illuminator 80.

The blue light LB propagates through the interior of the rod lens 84 while being totally reflected therein and exits via the light exiting end surface 84b with the uniformity of the illuminance distribution of the blue light LB enhanced. The blue light LB output from the rod lens 84 enters the relay lens 85. The relay lens 85 causes the blue light LB with the uniformity of the illuminance distribution enhanced by the rod lens 84 to be incident on the reflection mirror 9.

The light modulator 4R modulates the red light LR in accordance with image information to form image light corresponding to the red light LR. The light modulator 4G modulates the green light LG in accordance with image information to form image light corresponding to the green light LG. The light modulator 4B modulates the blue light LB in accordance with image information to form image light corresponding to the blue light LB. The light modulators 4R, 4G, and 4B can each, for example, be a transmissive liquid crystal panel. Polarizer plates that are not shown are disposed on the light incident side and the light exiting side of each of the light modulators 4R, 4G, and 4B. The polarizer plates each transmit only linearly polarized light polarized in a specific direction. The red light LR and the green light LG are two types of light into which the second light L2 is separated by the dichroic mirror 7, as described above. The light modulators 4R, 4G, and 4B therefore modulate light containing the second light L2.

A field lens 10R is disposed on the light incident side of the light modulator 4R. The field lens 10R parallelizes the chief ray of the red light LR to be incident on the light modulator 4R. A field lens 10G is disposed on the light incident side of the light modulator 4G. The field lens 10G parallelizes the chief ray of the green light LG to be incident on the light modulator 4G. A field lens 10B is disposed on the light incident side of the light modulator 4B. The field lens 10B parallelizes the chief ray of the blue light LB to be incident on the light modulator 4B.

The light combiner 5 combines the three types of image light, which are the result of the modulation performed by the light modulators 4R, 4G, and 4B, with one another, and outputs the combined image light toward the projection optical apparatus 6. The light combiner 5 can, for example, be a cross dichroic prism.

The projection optical apparatus 6 is configured with multiple projection lenses that are not shown. The projection optical apparatus 6 enlarges the combined image light from the light combiner 5 and projects the enlarged image light toward the screen SCR. A color image is thus displayed on the screen SCR.

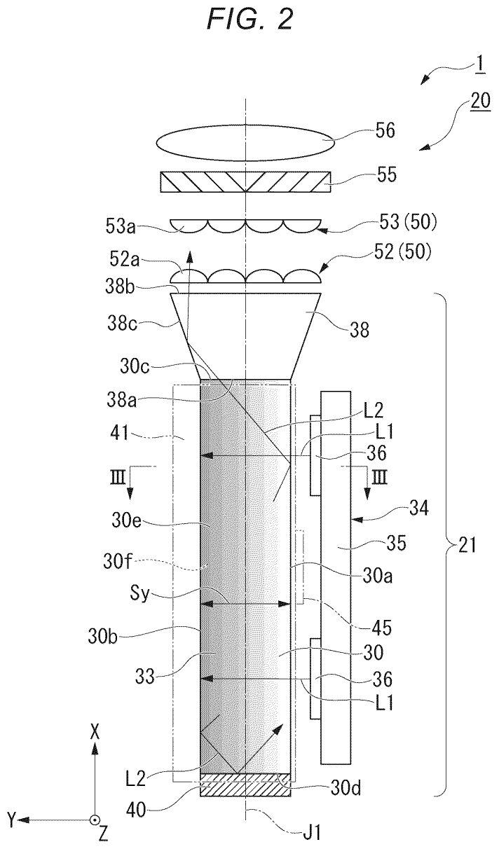

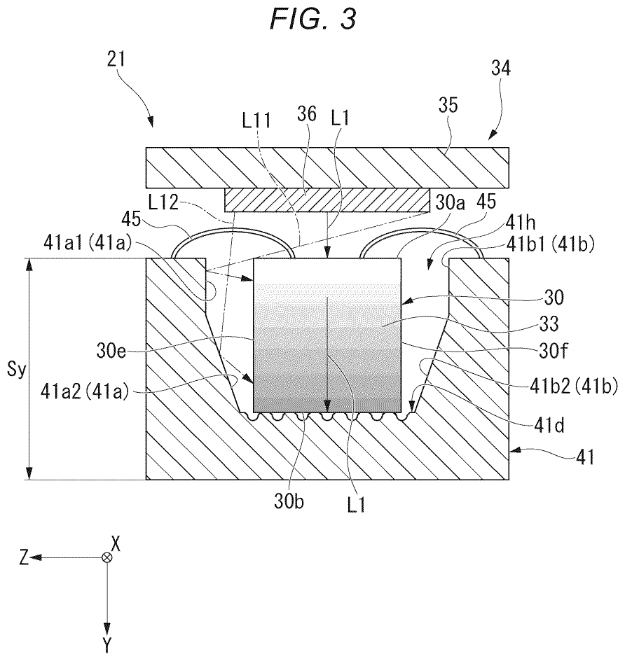

FIG. 2 is a schematic configuration diagram of the first Illuminator 20 in the present embodiment. FIG. 3 is a cross-sectional view of a light source apparatus 21 taken along the line III-III in FIG. 2. The first illuminator 20 includes the light source apparatus 21, an optical integration system 50, a polarization converter 55, and a superimposing system 56, as shown in FIG. 2.

The light source apparatus 21 converts first light L1 into the yellow second light L2, and outputs the second light L2 toward the optical integration system 50. The light source apparatus s 21 includes a wavelength converter 30, a light source section 34, an angle converting member 38, and a mirror 40. The light source apparatus 21 further includes a support member 41 and pressing members 45, as shown in FIG. 3.

The wavelength converter 30 shown in FIG. 2 has a quadrangular prismatic shape extending in the X-axis direction. The dimension of the wavelength converter 30 in the X-axis direction is greater than each of the dimensions thereof in the Y-axis and Z-axis directions. In the present embodiment, the X-axis direction is the longitudinal direction of the wavelength converter 30. In the following description, the X-axis direction is referred to as the longitudinal direction in some cases. The longitudinal direction is parallel to the direction in which the first optical axis J1 extends. The dimension of the wavelength converter 30 in the Y-axis direction and the dimension of the wavelength converter 30 in the Z-axis direction are substantially equal to each other. The wavelength converter 30 therefore has a substantially square cross-sectional shape when taken along a plane perpendicular to the longitudinal direction. The wavelength converter 30 may have another cross-sectional shape such as a rectangular cross-sectional shape when taken along a plane perpendicular to the longitudinal direction. In the following description, the Y-axis direction may be referred to as a light incident direction. The light incident direction is the direction in which the first light L1 enters the wavelength converter 30, as will be described later. The light incident direction is also the direction in which the light source section 34 outputs the first light L1.

The wavelength converter 30 has six surfaces. The wavelength converter 30 has a first surface 30a and a second surface 30b, which are perpendicular to the light incident direction (Y-axis direction) and are located on opposite sides in the light incident direction. The second surface 30b is disposed away from the first surface 30a in the light incident direction. The second surface 30b faces the side opposite the first surface 30a. A dimension Sy of the wavelength converter 30 in the light incident direction is the distance between the first surface 30a and the second surface 30b.

The wavelength converter 30 has a third surface 30c and a fourth surface 30d, which are perpendicular to the longitudinal direction (X-axis direction) and are located on opposite sides in the light longitudinal direction. The fourth surface 30d is disposed away from the third surface 30c in the longitudinal direction. The fourth surface 30d faces the side opposite the third surface 30c. The third surface 30c and the fourth surface 30d each intersect with both the first surface 30a and the second surface 30b. In the present embodiment, the third surface 30c and the fourth surface 30d are each perpendicular to both the first surface 30a and the second surface 30b.

The wavelength converter 30 has a fifth surface 30e and a sixth surface 30f, which are perpendicular to the Z-axis direction and located on opposite sides in the Z-axis direction, as shown in FIG. 3. In the following description, the first surface 30a, the second surface 30b, the fifth surface 30e, and the sixth surface 30f may each be referred to as a “side surface”.

The wavelength converter 30 converts the first light L1 having a first wavelength band into the second light L2 having a second wavelength band different from the first wavelength band, as shown FIG. 2. The wavelength converter 30 outputs the second light L2 toward the angle converting member 38. The first light L1 is output from the light source section 34 in the light incident direction (Y-axis direction), and enters the wavelength converter 30 via the first surface 30a. The second light L2 is guided through the interior of the wavelength converter 30 and is then output via the third surface 30c toward the angle converting member 38. In other words, the third surface 30c causes the second light L2 to exit.

The wavelength converter 30 contains a phosphor 33. The phosphor 33 converts the first light L1 into the second light L2. In the present embodiment, the wavelength converter 30 is made, for example, of fluorescent glass that is glass in which rare earth ions are dispersed, a ceramic phosphor made of a single crystal phosphor or a polycrystalline phosphor, or a material in which the phosphor 33 is dispersed in a binder such as a resin. The fluorescent glass may, for example, be LUMILASS (product name, manufactured by Sumita Optical Glass, Inc.). The phosphor 33 contains, for example, a YAG-based phosphor (any of Ce:YAG, Pr:YAG, Eu:YAG, and Cr:YAG) made of (Y_{1-x-y}, Gdₓ, Lu_{y})₃(Al,Ga)₅O₁₂ in which any of Ce, Pr, Eu, and Cr is dispersed as an activator. The activator absorbs the first light L1 and outputs the second light L2, which is yellow fluorescence. The activator may contain one element selected from Ce, Pr, Eu, and Cr, or may contain multiple elements selected from Ce, Pr, Eu, and Cr. The wavelength converter 30 is made of a material in which a large number of phosphor particles are dispersed in a binder. In the following description, the activator contained in the phosphor 33 is referred to as fluorescent emission points in some cases. In the following description, the ratio (atomic percent, at %) of the activator atoms to the wavelength converter 30 is referred to as a density Dp of the fluorescence emission points. The density Dp of the fluorescence emission points of the wavelength converter 30 will be described later in detail.

In the wavelength converter 30 in the present embodiment, the density Dp of the fluorescence emission points in the light incident direction (Y-axis direction) continuously changes, as will be described later. To this end, the wavelength converter 30 is desirably formed by a Czochralski method (CZ method). The density Dp of the fluorescence emission points in the light incident direction can thus be smoothly changed. Note that the wavelength converter 30 may instead be formed by a floating zone method (FZ method).

When the first light L1 enters the wavelength converter 30, the phosphor 33 absorbs the first light L1 and outputs the second light L2 having the second wavelength band. The wavelength converter 30 thus converts the first light L1 into the second light L2. In the present embodiment, the second light L2 is yellow fluorescence containing a red light component and a green light component. The second wavelength band, to which the second light L2 belongs, is, for example, a wavelength band of yellow light having wavelengths ranging from 490 nm to 750 nm. When the phosphor 33 absorbs the first light L1, the phosphor 33 generates heat.

The light source section 34 irradiates the wavelength converter 30 with the first light L1. The light source section 34 is disposed so as to face the first surface 30a of the wavelength converter 30 in the light incident direction (Y-axis direction). The light source section 34 includes a substrate 35 and a light emitter 36. That is, the light source apparatus 21 includes the light emitter 36. The light source section 34 may further include other optical members such as a light guide plate, a diffuser plate, and a lens.

The substrate 35 supports the light emitter 36. The light emitter 36 is provided at one of the outer surface of the substrate 35 that faces the first surface 30a of the wavelength converter 30 in the light incident direction (Y-axis direction).

The light emitter 36 is configured, for example, with a light emitting diode. The light emitter 36 emits the first light L1 having the first wavelength band toward the first surface 30a of the wavelength converter 30. The first light L1 is thus incident on the first surface 30a. The first light L1 enters the wavelength converter 30 via the first surface 30a. In the present embodiment, the first wavelength band has, for example, a wavelength range from 400 nm to 480 nm corresponding to a color range from blue to purple. The peak wavelength of the first light L1 is, for example, 445 nm. The light source section 34 includes multiple light emitters 36. In the present embodiment, the light source section 34 includes two light emitters 36. The light emitters 36 are arranged side by side in the longitudinal direction (X-axis direction). The light emitters 36 each face the first surface 30a in the light incident direction (Y-axis direction). The number of the light emitters 36 provided in the light source section 34 is not limited to a specific number, and may be one or three or more.

The support member 41 surrounds the wavelength converter 30, as shown in FIG. 3. The support member 41 supports the second surface 30b of the wavelength converter 30 in the light incident direction (Y-axis direction). Heat generated by the wavelength converter 30 is transferred to the support member 41, which dissipates the heat out of the light source apparatus 21. It is therefore desirable that the support member 41 is made of a material having a predetermined strength and high thermal conductivity. The support member 41 may be made of a metal, for example, aluminum or stainless steel. As the material of the support member 41, it is particularly desirable to use an aluminum alloy, such as 6061 series. In the present embodiment, the thermal conductivity of the support member 41 is higher than the thermal conductivity of the wavelength converter 30. The support member 41 has a first wall surface 41a, a second wall surface 41b, a support surface 41d, and a housing recess 41h.

The housing recess 41h is a recess recessed in the light incident direction from one of the outer surfaces of the support member 41 that faces the light source section 34 in the light incident direction (Y-axis direction). The wavelength converter 30 is housed in the housing recess 41h.

The support surface 41d is the bottom surface of the housing recess 41h. The support surface 41d supports the second surface 30b of the wavelength converter 30 in the light incident direction. The support member 41 thus supports the wavelength converter 30. Note that heat conductive grease may be disposed between the support surface 41d and the second surface 30b. The thermal resistance between the wavelength converter 30 and the support member 41 can thus be reduced, so that the amount of heat transferred from the wavelength converter 30 to the support member 41 can be increased. The heat transfer can prevent the temperature of the wavelength converter 30 from becoming too high.

The first wall surface 41a is one side surface of the housing recess 41h. The first wall surface 41a faces the fifth surface 30e of the wavelength converter 30 in the Z-axis direction with a gap therebetween. The second wall surface 41b is the other side surface of the housing recess 41h. The second wall surface 41b faces the sixth surface 30f of the wavelength converter 30 in the Z-axis direction with a gap therebetween.

The first wall surface 41a has a first section 41al located far from the support surface 41d and a second section 41a2 located close to the support surface 41d. The first section 41a1 extends in the direction perpendicular to the support surface 41d. The second section 41a2 extends in a direction inclining with respect to the support surface 41d. The second section 41a2 is an inclining surface that approaches the wavelength converter 30 as approaching the support surface 41d.

The second wall surface 41b has a third section 41b1 located far from the support surface 41d and a fourth section 41b2 located close to the support surface 41d. The third section 41b1 extends in the direction perpendicular to the support surface 41d. The fourth section 41b2 extends in a direction inclining with respect to the support surface 41d. The fourth section 41b2 is an inclining surface that approaches the wavelength converter 30 as approaching the support surface 41d. In the present embodiment, the shape of the second wall surface 41b is symmetrical with the shape of the first wall surface 41a with respect to a plane extending in the direction perpendicular to the Z-axis direction as a symmetrical plane.

Out of the first light L1 emitted from the light emitters 36, first light L11, which enters the gap between the wavelength converter 30 and the first wall surface 41a, is reflected off the first section 41a1 and incident on the fifth surface 30e of the wavelength converter 30. Out of the first light L1 emitted from the light emitters 36, first light L12, which enters the gap between the wavelength converter 30 and the first wall surface 41a, is reflected off the second section 41a2 and incident on the fifth surface 30e of the wavelength converter 30. Although not shown, out of the first light L1 emitted from the light emitters 36, first light that enters the gap between the wavelength converter 30 and the second wall surface 41b is reflected off the third section 41b1 or the fourth section 41b2 and incident on the sixth surface 30f of the wavelength converter 30, as the first light L11 and the first light L12 are. Since the amount of the first light L1 reflected off the support surface 41d and returning to the light source section 34 can thus be reduced, the efficiency at which the first light L1 is used can be increased.

The first wall surface 41a and the second wall surface 41b are each preferably a processed surface on which mirror finishing has been performed. The reflectance of the first wall surface 41a and the second wall surface 41b can thus be increased. Since the first light L1 incident on the first wall surface 41a and the second wall surface 41b can therefore be preferably reflected toward the wavelength converter 30, the efficiency at which the first light L1 is used can be increased.

The pressing members 45 press the wavelength converter 30 against the support member 41. In more detail, the pressing members 45 press the wavelength converter 30 against the support surface 41d. The pressing members 45 are each configured, for example, with an elastic member such as a plate spring. One end of each of the pressing members 45 is linked to the support member 41. The other end of each of the pressing members 45 is caused to be in contact with the first surface 30a of the wavelength converter 30. The wavelength converter 30 is pressed against the support surface 41d by the elastic force produced by the pressing members 45. Since the adhesion between the wavelength converter 30 and the support surface 41d can thus be enhanced, the thermal resistance between the wavelength converter 30 and the support surface 41d can be reduced. Heat generated by the wavelength converter 30 can therefore be more preferably transferred to the support member 41. The heat transfer can more preferably prevent the temperature of the wavelength converter 30 from becoming too high.

The mirror 40 is provided at the fourth surface 30d of the wavelength converter 30, as shown in FIG. 2. The mirror 40 reflects the second light L2 having been guided through the interior of the wavelength converter 30 and having reached the fourth surface 30d. The mirror 40 is configured with a metal film or a dielectric multilayer film formed at the fourth surface 30d.

The first light L1 emitted from the light emitters 36 toward the first surface 30a enters the wavelength converter 30 via the first surface 30a. When the first light L1 enters the wavelength converter 30, the phosphor 33 is excited by the first light L1, so that the second light L2 is emitted at the fluorescence emission points. The second light L2 travels radially from each of the fluorescence emission points, the fluorescence emission points being as the center. The second light L2 traveling toward the four side surfaces 30a, 30b, 30e, and 30f of the wavelength converter 30 travels toward the third surface 30c or the fourth surface 30d while repeatedly totally reflected off the side surfaces 30a, 30b, 30e, and 30f. The second light L2 traveling toward the fourth surface 30d is reflected off the mirror 40 and travels toward the third surface 30c. The entire second light L2 emitted at the fluorescence emission points thus travels toward the third surface 30c, passes through the third surface 30c, and enters the angle converting member 38.

A portion of the second light L2 exits out of the wavelength converter 30 via the first surface 30a. Part of the second light L2 having exited out of the wavelength converter 30 via the first surface 30a is reflected off members around the wavelength converter 30, which include the light source section 34, enters the wavelength converter 30 via the first surface 30a and other surfaces, and exits via the third surface 30c. The intensity of the second light L2 that exits via the third surface 30c is greater than the intensity of the second light L2 that exits via the first surface 30a.

The angle converting member 38 is provided on the light exiting side of the third surface 30c of the wavelength converter 30. The second light L2 having exited via the third surface 30c enters the angle converting member 38. The angle converting member 38 is configured, for example, with a light transmissive member such as a tapered rod. The angle converting member 38 has a light incident surface 38a, on which the second light L2 output from the wavelength converter 30 is incident, a light exiting surface 38b, via which the second light L2 exits, and a reflection side surface 38c, which reflects the second light L2 toward the light exiting surface 38b. The light incident surface 38a faces the third surface 30c in the longitudinal direction (X-axis direction).

The angle converting member 38 has a truncated quadrangular pyramidal shape, and has a cross section perpendicular to the first optical axis J1 and having a cross-sectional area that increases along the traveling direction of the second light L2. The area of the light exiting surface 38b is therefore greater than the area of the light incident surface 38a. Note in the present embodiment that the optical axis of the angle converting member 38 coincides with the first optical axis J1. The optical axis of the angle converting member 38 does not need to coincide with the first optical axis J1.

The traveling direction of the second light L2 having entered the angle converting member 38 is changed so as to approach the direction parallel to the first optical axis J1 whenever the second light L2 is reflected off the reflection side surface 38c. The angle converting member 38 thus changes the exiting angle distribution of the second light L2 output from the wavelength converter 30. In general, since the etendue of light specified by the product of the area of a light exiting region and the solid angle (largest exiting angle) of the light is preserved, the etendue of the second light L2 is preserved before and after the second light L2 passes through the angle converting member 38. The area of the light exiting surface 38b is greater than the area of the light incident surface 38a, as described above. The largest exiting angle of the second light L2 exiting via the light exiting surface 38b is therefore smaller than the largest incident angle of the second light L2 incident on the light incident surface 38a in view of etendue preservation.

In the present embodiment, the light incident surface 38a of the angle converting member 38 is fixed to the third surface 30c of the wavelength converter 30 via an optical adhesive that is not shown. The angle converting member 38 and the wavelength converter 30 are therefore in contact with each other via the optical adhesive, so that no air gap is provided between the angle converting member 38 and the wavelength converter 30. When an air gap is provided between the angle converting member 38 and the wavelength converter 30, the second light L2 incident on the light incident surface 38a of the angle converting member 38 at angles greater than or equal to the critical angle out of the second light L2 having reached the light incident surface 38a is totally reflected off the light incident surface 38a and cannot therefore enter the angle converting member 38. In contrast, when no air gap is provided between the angle converting member 38 and the wavelength converter 30 as in the present embodiment, the amount of the second light L2 that cannot enter the angle converting member 38 can be reduced. It is desirable that the refractive index of the angle converting member 38 is as close as possible to the refractive index of the wavelength converter 30.

Note that the angle converting member 38 is not necessarily configured as in the present embodiment, and may, for example, be a compound parabolic concentrator (CPC). Even when a CPC is used as the angle converting member 38, the same advantages as those provided when the tapered rod described above is used can be provided. Furthermore, the light source apparatus 21 may not necessarily include the angle converting member 38.

The optical integration system 50 includes a first lens array 52 and a second lens array 53. The optical integration system 50 and the superimposing system 56 constitute a uniform illumination system that homogenizes the intensity distribution of the second light L2 output from the light source apparatus 21 in each of the light 4R and 4G, which are each an illumination modulators receiving region. The second light L2 output via the light exiting surface 38b of the angle converting member 38 enters the first lens array 52.

The first lens array 52 includes multiple first lenslets 52a. The first lenslets 52a divide the second light L2 output from the angle converting member 38 into multiple sub-luminous fluxes. The first lenslets 52a are arranged in a matrix in a plane perpendicular to the first optical axis J1. The first lenslets 52a each have a shape substantially similar to the shape of an image formation region of each of the light modulators 4R and 4G. The sub-luminous fluxes output from the first lens array 52 are thus each efficiently incident on the image formation region of each of the light modulators 4R and 4G.

The second lens array 53 is disposed on the light exiting side of the first lens array 52. The second light L2 output from the first lens array 52 enters the second lens array 53. The second lens array 53 includes multiple second lenslets 53a corresponding to the multiple first lenslets 52a. The second lens array 53 along with the superimposing system 56 brings the sub-luminous fluxes output from the first lenslets 52a into focus in the vicinity of the image formation region of each of the light modulators 4R and 4G.

The polarization converter 55 converts the polarization directions of the second light L2 output from the second lens array 53. In more detail, the polarization converter 55 converts each of the sub-luminous fluxes, into which the second light L2 has been divided by the first lens array 52 and which have been output from the second lens array 53, into linearly polarized light. The second light L2 output from the second lens array 53 enters the superimposing system 56. The superimposing system 56 causes the second light L2 to enter the color separation system 3.

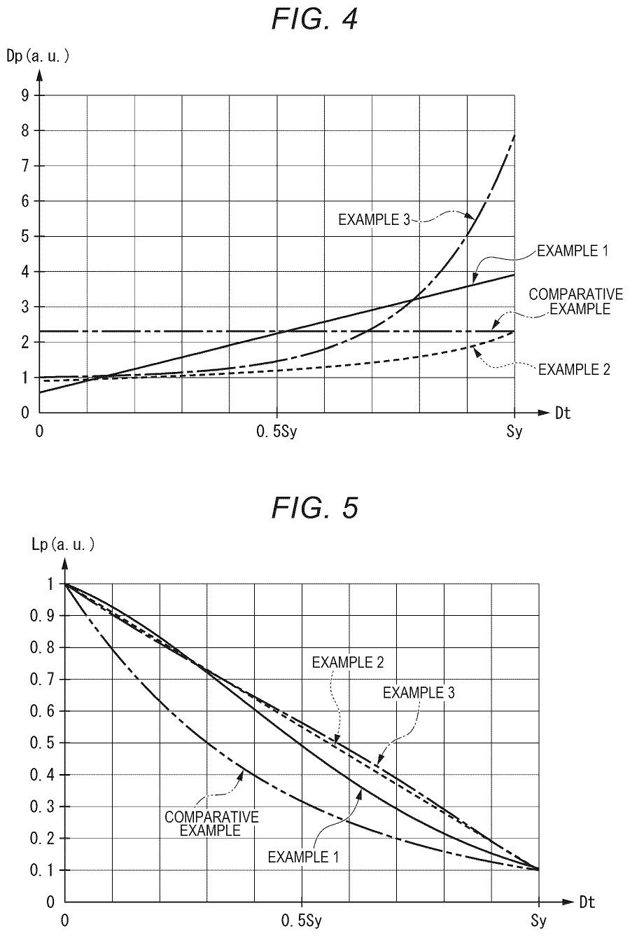

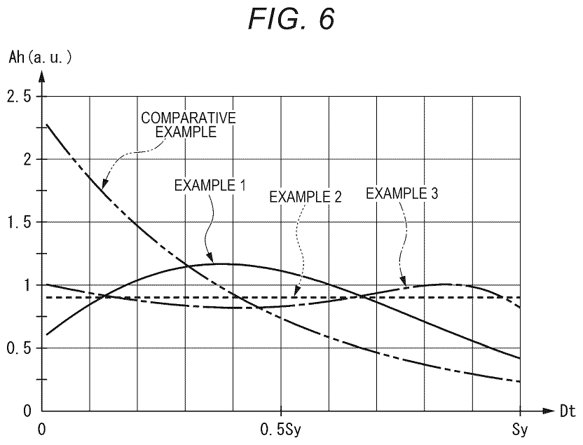

The density Dp of the fluorescence emission points of the wavelength converter 30 will next be described. The distribution of the density Dp of the fluorescence emission points in Examples 1 to 3 shown in FIG. 4, which will be described later, is applicable to the distribution of the density Dp of the fluorescence emission points in the wavelength converter 30 in the present embodiment. In the distributions of the density Dp of the fluorescence emitting points in Examples 1 to 3 and Comparative Example shown in FIG. 4, the wavelength converter 30 generates the same integrated amount of heat, which is the amount of heat Ah integrated in the light incident t direction (Y-axis direction) shown in FIG. 6, which will be described later. The following description will be made about the distribution of the density Dp of the fluorescence emitting points and the distribution of the amount of the heat generated by the wavelength converter 30 in the light incident direction in each of Examples 1 to 3 and Comparative Example. Note in the following description that the wavelength converters 30 in Examples 1 to 3 are simply referred to as Examples 1 to 3 in some cases. In the following description, the wavelength converter 30 in Comparative Example is simply referred to as Comparative Example in some cases. Furthermore, in the following description, the amount of the first light L1 absorbed by the phosphor 33 is simply referred to as “the amount of the absorbed first light L1” in some cases. The amount of the absorbed first light L1 correlates with both the intensity of the first light L1 and the density Dp of the fluorescence emitting points. The amount of the absorbed first light L1 increases as the intensity of the first light L1 increases. The amount of the absorbed first light L1 increases as the density Dp of the fluorescence emission points increases.

FIG. 4 shows the distribution of the density Dp of the fluorescence emission points of the wavelength converter 30 in the present embodiment in the light incident direction (Y-axis direction). The horizontal axis in FIG. 4 represents a distance Dt from the first surface 30a in the light incident direction. In the following description, the distance Dt from the first surface 30a in the light incident direction is simply referred to as the “distance Dt from the first surface 30a”. The origin of the horizontal axis in FIG. 4 is the position of the first surface 30a in the light incident direction. At the origin of the horizontal axis in FIG. 4, the first light L1 enters the wavelength converter 30. The dimension Sy of the wavelength converter 30 in the light incident direction is the distance between the first surface 30a and the second surface 30b, as described above. The second surface 30b is located at Sy on the horizontal axis in FIG. 4. The vertical axis in FIG. 4: represents the density Dp of the fluorescence emission points.

The density Dp of the fluorescence emission points in Example 1 increases along the direction from the first surface 30a toward the second surface 30b. The density Dp of the fluorescence emission points in Example 1 continuously increases along the direction from the first surface 30a toward the second surface 30b. In more detail, the density Dp of the fluorescence emission points in Example 1 linearly increases along the direction from the first surface 30a toward the second surface 30b. The density Dp of the fluorescence emission points in Comparative Example is uniform in the light incident direction.

FIG. 5 shows the distribution of the intensity of the first light L1 in the wavelength converter 30 in the present embodiment in the light incident direction (Y-axis direction). The horizontal axis in FIG. 5 represents the distance Dt from the first surface 30a. The vertical axis in FIG. 5 represents an intensity Lp of the first light L1. The intensity Lp of the first light L1 shown in FIG. 5 is normalized by the intensity of the first light L1 at the first surface 30a. The first light L1 having entered the wavelength converter 30 is absorbed by the phosphor 33 and converted into the second light L2, as described above. The intensity Lp of the first light L1 in Comparative Example and the intensity Lp of the first light L1 in Example 1 each therefore decreases from along the direction from the first surface 30a toward the second surface 30b. In more detail, the intensity Lp of the first light L1 in Comparative Example greatly decreases in a portion close to the first surface 30a and gradually decreases in a portion close to the second surface 30b. That is, in the wavelength converter 30 in Comparative Example, the first light L1 is absorbed by a greater amount in the portion closer to the first surface 30a. In contrast, in the wavelength converter 30 in Example 1, the intensity Lp of the first light L1 decreases more linearly than in Comparative Example along the direction from the first surface 30a toward the second surface 30b. A reason for this is that the density Dp of the fluorescence emission points in the portion close to the first surface 30a, where the intensity Lp of the first light L1 is high, is low, so that the amount of the first light L1 absorbed in the portion close to the first surface 30a is small. Another reason for this is that the density Dp of the fluorescence emission points in the portion close to the second surface 30b, where the intensity Lp of the first light L1 is low, is high, so that the amount of the first light L1 absorbed in the portion close to the second surface 30b is large. Variation in the amount of the absorbed first light L1 in the light incident direction can therefore be reduced in Example 1 as compared with the variation in Comparative Example. In particular, the amount of the absorbed first light L1 in the portion close to the first surface 30a can be reduced in Example 1 as compared with the amount in Comparative Example.

FIG. 6 shows the distribution of the amount of the heat generated by the wavelength converter 30 in the present embodiment in the light incident direction (Y-axis direction). The horizontal axis in FIG. 6 represents the distance Dt from the first surface 30a. The vertical axis in FIG. 6 represents the amount of the heat Ah generated in the wavelength converter 30. The same integrated amount of heat is generated in Example 1 and Comparative Example as described above. The phosphor 33 generates heat when absorbing the first light L1 and emitting the second light L2, as described above. The wavelength converter 30 therefore generates a greater amount of heat Ah in a portion that absorbs the first light L1 by a greater amount. The amount of generated heat Ah in Comparative Example increases along the direction from the second surface 30b toward the first surface 30a, as shown in FIG. 6. The reason for this is that the portion closer to the first surface 30a absorbs the first light L1 by a greater amount in Comparative Example. In Comparative Example, the portion close to the first surface 30a generates a large amount of heat Ah, so that the temperature of the portion close to the first surface 30a becomes too high. Accordingly, in Comparative Example, the amount of thermal quenching of the second light L2 in the portion close to the first surface 30a of the wavelength converter 30 tends to increase. Therefore, in Comparative Example, there is a concern about a decrease in the wavelength conversion efficiency, which is the efficiency at which the wavelength converter 30 converts the first light L1 into the second light L2.

As compared with Comparative Example, variation in the amount of generated heat Ah in the light incident direction (Y-axis direction) can be reduced in Example 1. The reason for this is that the variation in the amount of the absorbed first light L1 in the light incident direction is smaller in Example 1 than in Comparative Example. The situation in which the temperature of the phosphor 33 in the portion of the wavelength converter 30 that is close to the first surface 30a becomes too high can thus be avoided in Example 1, so that the amount of thermal quenching of the second light L2 in the portion described above can be reduced.

The density Dp of the fluorescence emission points in Example 2 continuously increases along the direction from the first surface 30a toward the second surface 30b, as shown in FIG. 4. In more detail, the density Dp of the fluorescence emission points in Example 2 super linearly increases along the direction from the first surface 30a toward the second surface 30b. In the present embodiment, the super-linear increase means that the gradient of the distribution curve of the density Dp of the fluorescence emission points increases along the direction from the first surface 30a toward the second surface 30b.

In Example 2, the intensity of the first light L1 decreases more linearly along the direction from the first surface 30a toward the second surface 30b than the intensity in Example 1, as shown in FIG. 5. The reason for this is that Example 2 allows suppression of an increase in the ratio of the density Dp of the fluorescence emission points at the center in the light incident direction (Y-axis direction) to the density Dp of the fluorescence emission points at the first surface 30a, and further allows a more preferable increase in the density Dp of the fluorescence emission points in the vicinity of the second surface 30b, as compared with Example 1. The variation in the amount of the absorbed first light L1 in the light incident direction can therefore be reduced in Example 2 as compared with the variation in Example 1. In particular, the amount of the absorbed first light L1 in the vicinity of the center in the light incident direction can be reduced in Example 2 as compared with the amount in Example 1. The variation in the amount of generated heat Ah in the light incident direction can therefore be reduced in Example 2 as compared with the variation in Example 1, as shown in FIG. 6. The situation in which the temperature of a portion of the wavelength converter 30 becomes too high can thus be avoided in Example 2, so that the amount of thermal quenching of the second light L2 can be more preferably reduced.

The density Dp of the fluorescence emission points in Example 3 continuously increases along the direction from the first surface 30a toward the second surface 30b, as shown in FIG. 4. The density Dp of the fluorescence emission points in Example 3 super linearly increases along the direction from the first surface 30a toward the second surface 30b. In more detail, in Example 3, the density Dp of the fluorescence emission points contained in the second surface 30b is greater than or equal to twice but smaller than or equal to nine times the density Dp of the fluorescence emission points contained in a central portion of the wavelength converter 30 in the light incident direction (Y-axis direction). Note that in Example 2, the density Dp of the fluorescence emission points contained in the second surface 30b is lower than twice the density Dp of the fluorescence emission points contained in the central portion of the wavelength converter 30 in the light incident direction.

In Example 3, since the density Dp of the fluorescence emission points in the portion close to the second surface 30b can higher than that in Example 2, the amount of decrease in the intensity Lp of the first light L1 in the portion close to the second surface 30b can be increased, as shown in FIG. 5. That is, in Example 3, the amount of the absorbed first light L1 in the portion close to the second surface 30b can be increased. Example 3 therefore allows reduction in the amount of the heat Ah generated in the central portion of the wavelength converter 30 in the light incident direction (Y-axis direction), and further allows an increase in the amount of the heat Ah generated in the portion close to the second surface 30b of the wavelength converter 30, as compared with Example 2, as shown in FIG. 6. Since the second surface 30b is supported by the support member 41 as described above, the heat generated in the portion of the wavelength converter 30 that is close to the second surface 30b is easily transferred to the support member 41. Therefore, in Example 3, the amount of the heat transferred from the wavelength converter 30 to the support member can be preferably increased. Accordingly, in Example 3, since the temperature of the wavelength converter 30 is easily reduced, the amount of thermal quenching of the second light L2 can be more preferably reduced.

According to the present embodiment, the light source apparatus 21 includes the light emitters 36, which emit the first light L1 having the first wavelength band, and the wavelength converter 30, which contains the phosphor 33, converts the first light L1 into the second light L2 having the second wavelength band different from the first wavelength band, and outputs the second light L2. The wavelength converter 30 has the first surface 30a, on which the first light L1 is incident, the second surface 30b, which faces the side opposite the first surface 30a, and the third surface 30c, which intersects with both the first surface 30a and the second surface 30b and via which the second light L2 exits, and the density Dp of the fluorescence emission points of the phosphor 33 increases along the direction from the first surface 30a toward the second surface 30b. The configuration described above allows a decrease in the density Dp of the fluorescence emission points in the portion close to the first surface 30a, where the intensity Lp of the first light L1 is high, and further allows an increase in the concentration Dp of the fluorescence emission points in the portion close to the second surface 30b, where the intensity Lp of the first light L1 is low, so that the amount of the first light L1 absorbed in the portion close to the first surface 30a can be reduced, as described above. The situation in which the temperature of the phosphor 33 in a portion of the wavelength converter 30 that is close to the first surface 30a becomes too high can thus be avoided as described above, so that the amount of thermal quenching of the second light L2 in the portion described above can be reduced. The wavelength conversion efficiency of the wavelength converter 30 can therefore be increased.

Furthermore, in the present embodiment, the variation in the amount of generated heat Ah in the light incident direction (Y-axis direction) can be reduced, as described above. Since the variation in the temperature of the wavelength converter 30 in the incident direction can be thus suppressed, so that the difference between the amount of thermal expansion of the portion of the wavelength converter 30 that is close to the first surface 30a and the amount of thermal expansion of the portion of the wavelength converter 30 that is close to the second surface 30b can be reduced. Deformation of the wavelength converter 30, such as warpage thereof, can therefore be suppressed.

According to the present embodiment, the density Dp of the fluorescence emission points continuously increases along the direction from the first surface 30a toward the second surface 30b. The variation in the amount of the absorbed first light L1 in the light incident direction (Y-axis direction) can therefore be reduced. A local increase in the amount of the heat generated in a portion of the wavelength converter 30 can therefore be readily suppressed. The situation in which the temperature of a portion of the wavelength converter 30 becomes too high can therefore be avoided, so that the amount of thermal quenching of the second light L2 in the wavelength converter 30 can be more preferably reduced. The wavelength conversion efficiency of the wavelength converter 30 can therefore be more preferably increased.

According to the present embodiment, the density Dp of the fluorescence emission points super linearly increases along the direction from the first surface 30a toward the second surface 30b. The present embodiment therefore allows suppression of an increase in the ratio of the density Dp of the fluorescence emission points at the center of the wavelength converter 30 in the light incident direction (Y-axis direction) to the density Dp of the fluorescence emission points at the first surface 30a, and further allows a more preferable increase in the density Dp of the fluorescence emission points in the vicinity of the second surface 30b, as described above. The amount of the first light L1 can therefore be reduced more linearly along the direction from the first surface 30a toward the second surface 30b. The variation in the amount of the absorbed first light L1 in the light incident direction can therefore be more preferably reduced as described above. The situation in which the temperature of a portion of the wavelength converter 30 becomes too high can therefore be more preferably avoided, so that the amount of thermal quenching of the second light L2 in the wavelength converter 30 can be more preferably reduced. The wavelength conversion efficiency of the wavelength converter 30 can therefore be more preferably increased.

According to the present embodiment, the density Dp of the fluorescence emission points contained in the second surface 30b out of the wavelength converter 30 is greater than or equal to twice but smaller than or equal to nine times the density Dp of the fluorescence emission points contained in the central portion of the wavelength converter 30 in the light incident direction (Y-axis direction). The density Dp of the fluorescence emission points in the portion close to the second surface 30b can therefore be more preferably increased, the amount of the first light L1 absorbed in the portion close to the second surface 30b can be increased, as described above. The present embodiment therefore allows reduction in the amount of the heat Ah generated in the central portion of the wavelength converter 30 in the light incident direction, and further allows an increase in the amount of the heat Ah generated in the portion close to the second surface 30b, as described above. The amount of the heat transferred from the wavelength converter 30 to the support member 41 can therefore be preferably increased, as described above. The temperature of the wavelength converter 30 is therefore readily reduced, so that the amount of thermal quenching of the second light L2 in the wavelength converter 30 can be more preferably reduced. The wavelength conversion efficiency of the wavelength converter 30 can therefore be more preferably increased.

According to the present embodiment, the light source apparatus 21 further includes the support member 41, which supports the second surface 30b, and the thermal conductivity of the support member 41 is higher than the thermal conductivity of the wavelength converter 30. The amount of the heat transferred from the wavelength converter 30 to the support member 41 can be more preferably increased. Furthermore, the amount of the heat dissipated out of the light source apparatus 21 via the support member 41 can be more preferably increased. The amount of the heat dissipated from the wavelength converter 30 out of the light source apparatus 21 via the support member 41 can therefore be further increased. The situation in which the temperature of the wavelength converter 30 becomes too high can therefore be more preferably avoided, so that the amount of thermal quenching of the second light L2 in the wavelength converter 30 can be more preferably reduced. The wavelength conversion efficiency of the wavelength converter 30 can therefore be more preferably increased.

According to the present embodiment, the light source apparatus 21 further includes the pressing members 45, which press the wavelength converter 30 against the support member 41. When the wavelength converter 30 is fixed to the support 1 member 41 with an adhesive, the reflectance of the second surface 30b for the second light L2 decreases, resulting in an increase in the second light L2 that passes through the second surface 30b and leaks out of the wavelength converter 30. The wavelength conversion efficiency of the wavelength converter 30 therefore decreases. In contrast, the present embodiment, in which the pressing members 45 press the wavelength converter 30 toward the support member 41 to fix the wavelength converter 30 to the support member 41, can suppress a decrease in the reflectance of the second surface 30b for the second light L2. The amount of the second light L2 that passes through the second surface 30b and leaks out of the wavelength converter 30 is therefore readily reduced, so that the wavelength conversion efficiency of the wavelength converter 30 can be increased.

When the wavelength converter 30 is fixed to the support member 41 with an adhesive, the wavelength converter 30 is unlikely to be deformed even when the temperature varies in the wavelength converter 30. Thermal stress acting on the wavelength converter 30 is therefore likely to increase, so that there is a concern about damage of the wavelength converter 30. In contrast, in the present embodiment, when the temperature varies in the wavelength converter 30, the wavelength converter 30 can be readily deformed in accordance with the thermal stress. An increase in the thermal stress acting on the wavelength converter 30 can therefore be suppressed, so that damage of the wavelength converter 30 can be suppressed.

In the present embodiment, since the second surface 30b of the wavelength converter 30 is pressed against the support member 41 by the pressing members 45, the thermal resistance between the second surface 30b and the support member 41 can be reduced. The amount of the heat transferred from the wavelength converter 30 to the support member 41 can therefore be more preferably increased. The situation in which the temperature of the wavelength converter 30 becomes too high can therefore be more preferably avoided, so that the amount of thermal quenching of the second light L2 in the wavelength converter 30 can be more preferably reduced. The wavelength conversion efficiency of the wavelength converter 30 can therefore be more preferably increased.

According to the present embodiment, the light source apparatus 21 further includes the angle converting member 38, which the second light L2 having exited via the third surface 30c enters. The angle converting member 38 has the light incident surface 38a, on which the second light L2 is incident, and the light exiting surface 38b, via which the second light L2 exits, and the maximum exiting angle of the second light L2 that exits via the light exiting surface 38b is smaller than the maximum incident angle of the second light L2 incident on the light incident surface 38a. The directivity of the second light L2 output from the angle converting member 38 can therefore be enhanced, so that the second light L2 efficiently enters the optical integration system 50 disposed downstream from the angle converting member 38. The angle converting member 38 can therefore increase the amount of the second light L2 output from the first Illuminator 20 toward the color separation system 3 and the light modulators 4R and 4G. The quality of an image displayed on the screen SCR can therefore be improved.

According to the present embodiment, the intensity of the second light L2 that exits via the third surface 30c is greater than the intensity of the second light L2 that exits via the first surface 30a. The present embodiment can increase the amount of the second light L2 that exits via the third surface 30c toward the color separation system 3 and the light modulators 4R and 4G. The quality of an image displayed on the screen SCR can therefore be improved.

According to the present embodiment, the projector 1 includes the light source apparatus 21, the light modulators 4R, 4G, and 4B, which modulate light containing the second light L2 output from the light source apparatus 21, and the projection optical apparatus 6, which projects the light modulated by the light modulators 4R, 4G, and 4B. In the present embodiment, the density Dp of the fluorescence emission points of the phosphor 33 increases along the direction from the first surface 30a toward the second surface 30b, as described above. The situation in which the temperature of the phosphor 33 in a portion of the wavelength converter 30 that is close to the first surface 30a becomes too high can thus be avoided as described above, so that the wavelength conversion efficiency of the wavelength converter 30 can be increased. The amount of the first light L1 required to cause the wavelength converter 30 to emit a predetermined amount of second light L2 can thus be reduced. The amount of the first light L1 emitted by the light emitters 36 can therefore be reduced, so that the power consumed by the projector 1 can be suppressed.

### Second Embodiment

A projector 201 according to a second embodiment will be described below.

The basic configuration of the projector 201 according to the present embodiment is the same as that of the projector 1 according to the first embodiment, and the projector 201 according to the present embodiment includes a wavelength converter 230 configured with multiple laminated plates 231 laminated on each other in the light incident direction (Y-axis direction). In the following description, elements having aspects that are the same as those of the projector 1 according to the first embodiment described above have the same reference characters, and will not be described.

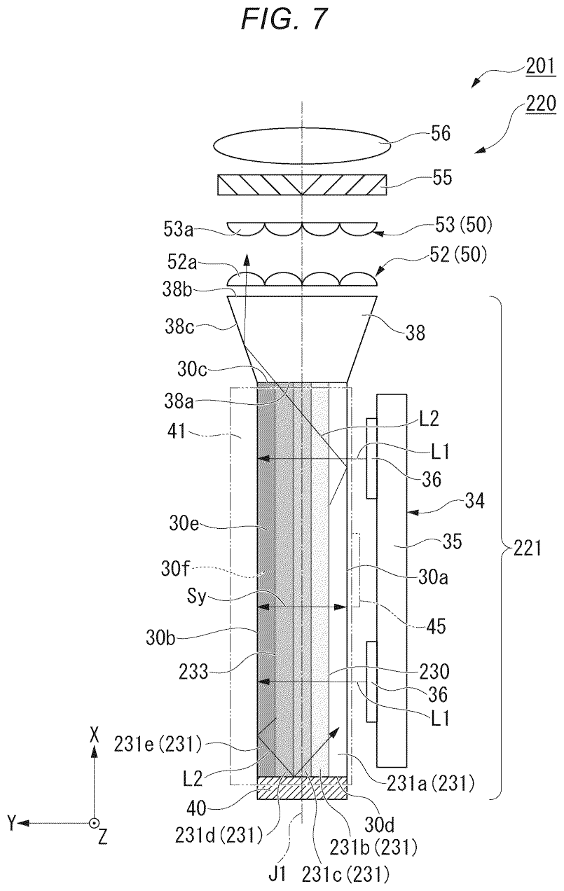

FIG. 7 is a schematic configuration diagram of a first Illuminator 220 in the present embodiment.

The first illuminator 220 includes a light source apparatus 221, the optical integration system 50, the polarization converter 55, and the superimposing system 56, as shown in FIG. 7. The configuration and other factors of the optical integration system 50, the polarization converter 55, and the superimposing system 56 in the present embodiment are the same as those of the optical integration system 50, the polarization converter 55, and the superimposing system 56 in the first embodiment described above.

The light source apparatus 221 converts the first light L1 into the yellow second light L2, and outputs the second light L2 toward the optical integration system 50. The light source apparatus 221 includes the wavelength converter 230, the light source section 34, the angle converting member 38, the mirror 40, the support member 41 (see FIG. 3), and the pressing members 45 (see FIG. 3).

The wavelength converter 230 converts the first light L1 having the first wavelength band into the second light L2 having the second wavelength band different from the first wavelength band. The wavelength converter 230 has a quadrangular prismatic shape extending in the X-axis direction. The dimension of the wavelength converter 230 in the X-axis direction is greater than each of the dimensions thereof in the Y-axis and Z-axis directions. The wavelength converter 230 has the first surface 30a, the second surface 30b, the third surface 30c, the fourth surface 30d, the fifth surface 30e, and the sixth surface 30f. The first surface 30a and the second surface 30b are perpendicular to the light incident direction (Y-axis direction) and are located on sides opposite each other in the light incident direction. The third surface 30c intersects with both the first surface 30a and the second surface 30b. In the present embodiment, the third surface 30c is perpendicular to both the first surface 30a and the second surface 30b. The third surface 30c causes the second light L2 to exit toward the angle converting member 38.

In the present embodiment, the wavelength converter 230 is configured with the multiple laminated plates 231 laminated on each other in the light incident direction (Y-axis direction). The laminated plates 231 each have the shape of a plate extending in the longitudinal direction (X-axis direction). The plate surfaces of each of the laminated plates 231 face the light incident thereon. Although not shown, the laminated plates 231 each have a substantially rectangular shape having long sides extending in the longitudinal direction when viewed in the light incident direction. In the present embodiment, the wavelength converter 230 is configured with five laminated plates 231. The five laminated plates 231 include laminated plates 231a, 231b, 231c, 231d, and 231e. The five laminated plates 231 are arranged in the order of the laminated plates 231a, 231b, 231c, 231d, and 231e from the side facing the light source section 34. The laminated plates 231 are fixed to each other via an optical adhesive. The number of the laminated plates 231, which constitute the wavelength converter 230, is not limited to five, and may be four or less or six or more.

In the present embodiment, the first surface 30a is one of the outer surfaces of the laminated plate 231a that faces the light source section 34 in the light incident direction. The second surface 30b is one of the outer surfaces of the laminated plate 231e that faces the side opposite the first surface 30a. The third surface 30c is configured with ones of the outer surfaces of the laminated plates 231 that face the angle converting member 38 in the longitudinal direction. The fourth surface 30d is configured with ones of the outer surfaces of the laminated plates 231 that face the side opposite the surface that constitutes the third surface 30c. The fifth surface 30e is configured with ones of the outer surfaces of the laminated plates 231 that face one side in the Z-axis direction. The sixth surface 30f is configured with ones of the outer surfaces of the laminated plates 231 that face the other side in the Z-axis direction.

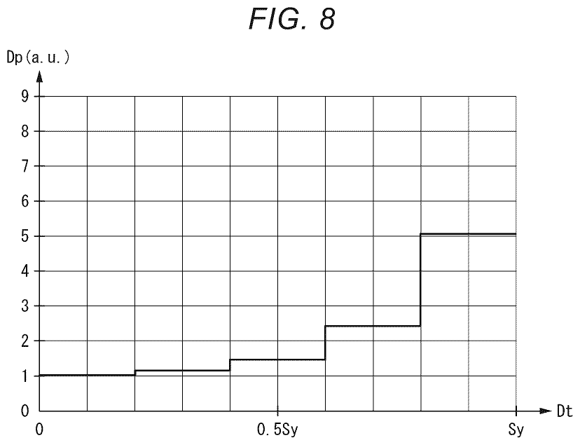

In the present embodiment, the density Dp of fluorescence emission points contained in the laminated plate 231b is higher than the density Dp of the fluorescence emission points contained in the laminated plate 231a. The density Dp of the fluorescence emission points contained in the laminated plate 231c is higher than the density Dp of the fluorescence emission points contained in the laminated plate 231b. The density Dp of the fluorescence emission points contained in the laminated plate 231d is higher than the density Dp of the fluorescence emission points contained in the laminated plate 231c. The density Dp of the fluorescence emission points contained in the laminated plate 231e is higher than the density Dp of the fluorescence emission points contained in the laminated plate 231d. The density Dp of the fluorescence emission points contained in each of the multiple laminated plates 231 is higher than the density Dp of the fluorescence emission points contained in another laminated plate 231 disposed on the side facing the first surface 30a. The density Dp of the fluorescence emission points of a phosphor 233 of the wavelength converter 230 therefore increases along the direction from the first surface 30a toward the second surface 30b, as shown in FIG. 8. In more detail, the density Dp of the fluorescence emission points of the phosphor 233 of the wavelength converter 230 increases stepwise from the first surface 30a along the direction toward the second surface 30b. The other configurations and the like of the wavelength converter 230 in the present embodiment are the same as those of the wavelength converter 30 in the first embodiment described above.

According to the present embodiment, the density Dp of the fluorescence emission points of the phosphor 233 of the wavelength converter 230 increases along the direction from the first surface 30a toward the second surface 30b. Therefore, although not shown, the density Dp of the fluorescence emission points in a portion close to the first surface 30a, where the intensity Lp of the first light L1 is high, can be low, and the density Dp of the fluorescence emission points in a portion close to the second surface 30b, where the intensity Lp of the first light L1 is low, can be high, as in the first embodiment described above. The amount of the absorbed first light L1 in the portion close to the first surface 30a can therefore be reduced. The situation in which the temperature of the phosphor 233 in the portion of the wavelength converter 230 that is close to the first surface 30a becomes too high can thus be avoided, so that the amount of thermal quenching of the second light L2 in the portion described above can be reduced. The wavelength conversion efficiency of the wavelength converter 230 can therefore be increased.

According to the present embodiment, the wavelength converter 230 is configured with the multiple laminated plates 231 laminated on each other in the light incident direction (Y-axis direction), and the density Dp of the fluorescence emission points contained in each of the multiple laminated plates 231 is higher than the density Dp of the fluorescence emission points contained in another laminated plate 231 disposed on the side facing the first surface 30a. The wavelength converter 230 can therefore be configured with the multiple laminated plates 231, in each of which the density Dp of the fluorescence emission points is known in advance, so that the wavelength converter 230 readily has stable f fluorescence emission point density distribution in the light incident direction is as compared with the case where the wavelength converter 230 is configured as an integrated unit. The density Dp of the fluorescence emission points of the phosphor 233 of the wavelength converter 230 is therefore readily increased in a stable manner along the direction from the first surface 30a toward the second surface 30b. The situation in which the temperature of the phosphor 233 in the portion of the wavelength converter 230 that is close to the first surface 30a becomes too high can thus be more preferably avoided, so that the amount of thermal quenching of the second light L2 in the portion described above can be more preferably reduced. The wavelength conversion efficiency of the wavelength converter 230 can therefore be more preferably increased.

The embodiments of the present disclosure have been described above, and the technical scope of the present disclosure is not limited to the embodiments described above, and various changes can be made thereto without departing from the intent of the present disclosure. An aspect of the present disclosure can have a configuration that is an appropriate combination of the characteristic portions in the embodiments described above.

For example, the distribution of the density of the fluorescence emission points of the wavelength converter in the light incident direction is not limited to that in the embodiments described above, and may be another density distribution such as a density distribution curve representing that the density increases in a sublinear manner in which the gradient of the density curve of the fluorescence emission points decreases along the direction from the first surface to the second surface. Even in such a fluorescence emission point density distribution, the situation in which the temperature of the phosphor in the portion of the wavelength converter that is close to the first surface becomes too high can be avoided, so that the wavelength conversion efficiency of the wavelength converter can be increased.

The shapes, the numbers, the arrangements, the materials, and other factors of the elements of the light source apparatus and the projector are not limited to those in the embodiments described above and can be changed as appropriate. The aforementioned embodiments have been described with reference to the case where the light source apparatus is incorporated in a projector using liquid crystal panels, and the light source apparatus may be incorporated in a projector using a digital micromirror device as a light modulator. The projector may not include multiple light modulators, and may include only one light modulator. The light source apparatus may be used as a lighting apparatus, a headlight of an automobile, and other apparatuses.

The present disclosure will be summarized below as additional remarks.

### Additional Remark 1

A light source apparatus including: a light emitter configured to emit first light having a first wavelength band; and a wavelength converter containing a phosphor and configured to convert the first light into second light having a second wavelength band different from the first wavelength band and output the second light, in which the wavelength converter has a first surface on which the first light is incident, a second surface facing a side opposite the first surface, and a third surface which intersects with both the first and second surfaces and via which the second light exits, and a density of fluorescence emission points of the phosphor increases along a direction from the first surface toward the second surface.

The light source apparatus having the configuration described in Additional remark 1 allows a decrease in the density of the fluorescent light emission points in a portion close to the first surface, where the intensity of the first light is high, and further allows an increase in the density of the fluorescent light emission points in a portion close to the second surface, where the intensity of the first light is low, so that the amount of absorbed first light in the portion close to the first surface can be reduced. The situation in which the temperature of the phosphor in the portion of the wavelength converter that is close to the first surface becomes too high can thus be avoided, so that the amount of thermal quenching of the second light in the portion described above can be reduced. The wavelength conversion efficiency of the wavelength converter can therefore be increased.

### Additional Remark 2

The light source apparatus according to Additional remark 1, in which the density of the fluorescence emission points continuously increases along the direction from the first surface toward the second surface.

According to the configuration described above, variation in the amount of the absorbed first light in the light incident direction can be reduced, so that a local increase in the amount of the heat generated in a portion of the wavelength converter can be readily suppressed. The situation in which the temperature of a portion of the wavelength converter becomes too high can therefore be avoided, so that the amount of thermal quenching of the second light in the wavelength converter can be more preferably reduced. The wavelength conversion efficiency of the wavelength converter can therefore be more preferably increased.

### Additional Remark 3

The light source apparatus according to Additional remark 2, in which the density of the fluorescence emission points super linearly increases along the direction from the first surface toward the second surface.

The configuration described above allows suppression of an increase in the ratio of the density of the fluorescence emission points at the center in the light incident direction to the density of the fluorescence emission points at the first surface, and further allows a more preferable increase in the density of the fluorescence emission points in the vicinity of the second surface, so that the variation in the amount of the absorbed first light in the light incident direction can be reduced. The situation in which the temperature of a portion of the wavelength converter becomes too high can therefore be more preferably avoided. The wavelength conversion efficiency of the wavelength converter can therefore be more preferably increased.

### Additional Remark 4

The light source apparatus according to Additional remark 2 or 3, in which the second surface is disposed away from the first surface in a light incident direction in which the first light enters the wavelength converter, and the density of the fluorescence emission points contained in the second surface of the wavelength converter is greater than or equal to twice but smaller than or equal to nine times the density of the fluorescence emission points contained in a central portion of the wavelength converter in the light incident direction.

According to the configuration described above, the concentration of the fluorescence emission points in a portion close to the second surface can be more preferably increased, so that the amount of the absorbed first light in the portion close to the second surface can be increased. The amount of the heat generated in the portion close to the second surface can thus be increased. The amount of the heat transferred from the wavelength converter to the support member can therefore be preferably increased, so that the temperature of the wavelength converter can be readily lowered. The wavelength conversion efficiency of the wavelength converter can therefore be more preferably increased.

### Additional Remark 5

The light source apparatus according to Additional remark 1, in which the wavelength converter is configured with multiple laminated plates laminated on each other in a light incident direction in which the first light enters the wavelength converter, and the density of the fluorescence emission points contained in each of the multiple laminated plates is higher than the density of the fluorescence emission points contained in another laminated plate disposed on a side close to the first surface.

According to the configuration described above, the wavelength converter can be configured with the multiple laminated plates, in each of which the density of the fluorescence emission points is known in advance, so that the density of the fluorescence emission points is readily increased along the direction from the first surface toward the second surface. The situation in which the temperature of the phosphor in a portion of the wavelength converter that is close to the first surface becomes too high can therefore be more preferably avoided. The wavelength conversion efficiency of the wavelength converter can therefore be more preferably increased.

### Additional Remark 6

The light source apparatus according to any one of Additional remarks 1 to 5, further including a support member configured to support the second surface, in which thermal conductivity of the support member is higher than thermal conductivity of the wavelength converter.

According to the configuration described above, the amount of the heat dissipated from the wavelength converter out of the light source apparatus via the support member can be further increased. The heat transfer can more preferably prevent the temperature of the wavelength converter from becoming too high. The wavelength conversion efficiency of the wavelength converter can therefore be more preferably increased.

### Additional Remark 7

The light source apparatus according to Additional remark 6, further including a pressing member configured to press the wavelength converter against the support member.

The configuration described above, in which the pressing member presses the wavelength converter toward the support member to fix the wavelength converter to the support member, can suppress a decrease in the reflectance of the second surface for the second light. The amount of the second light that passes through the second surface and leaks out of the wavelength converter is therefore readily reduced, so that the wavelength conversion efficiency of the wavelength converter can be increased.

### Additional Remark 8

The light source apparatus according to any one of Additional remarks 1 to 7, further including an angle converting member that the second light exiting via the third surface enters, in which the angle converting member has a light incident surface on which the second light is incident, and a light exiting surface via which the second light exits, and a maximum exiting angle of the second light exiting via the light exiting surface is smaller than a maximum incident angle of the second light incident on the light incident surface.

According to the configuration described above, the directivity of the second light output from the angle converting member can be enhanced, so that the angle converting member can increase the amount of the second light that is output from the first Illuminator and enters a color separation system and a light modulator. The quality of an image displayed on a screen can therefore be improved.

### Additional Remark 9

The light source apparatus according to any one of Additional remarks 1 to 8, in which an intensity of the second light exiting via the third surface is higher than the intensity of the second light exiting via the first surface.

The configuration described above can increase the amount of the second light that exits via the third surface and enters the color separation system and the light modulator. The quality of an image displayed on a screen can therefore be improved.

### Additional Remark 10

A projector including: the light source apparatus according to any one of the additional remarks 1 to 9; a light modulator configured to modulate light containing the second light output from the light source apparatus; and a projection optical apparatus configured to project the light modulated by the light modulator.

According to the projector having the configuration described above, the wavelength conversion efficiency of the wavelength converter can be increased, so that the amount of the first light required to cause the wavelength converter to emit a predetermined amount of second light can be reduced. The amount of the first light emitted by the light emitter toward the wavelength converter can therefore be reduced, so that the power consumed by the projector can be suppressed.

What is claimed is:

1. A light source apparatus comprising:
a light emitter configured to emit first light having a first wavelength band; and
a wavelength converter containing a phosphor and configured to convert the first light into second light having a second wavelength band different from the first wavelength band and output the second light,
wherein the wavelength converter has a first surface on which the first light is incident, a second surface facing a side opposite the first surface, and a third surface which intersects with both the first and second surfaces and via which the second light exits, and
a density of fluorescence emission points of the phosphor increases along a direction from the first surface toward the second surface.

2. The light source apparatus according to claim 1, wherein
the density of the fluorescence emission points continuously increases along the direction from the first surface toward the second surface.

3. The light source apparatus according to claim 2, wherein
the density of the fluorescence emission points super linearly increases along the direction from the first surface toward the second surface.

4. The light source apparatus according to claim 2, wherein
the second surface is disposed away from the first surface in a light incident direction in which the first light enters the wavelength converter, and
the density of the fluorescence emission points contained in the second surface of the wavelength converter is greater than or equal to twice but smaller than or equal to nine times the density of the fluorescence emission points contained in a central portion of the wavelength converter in the light incident direction.

5. The light source apparatus according to claim 1, wherein
the wavelength converter is configured with multiple laminated plates laminated on each other in a light incident direction in which the first light enters the wavelength converter, and
the density of the fluorescence emission points contained in each of the multiple laminated plates is higher than the density of the fluorescence emission points contained in another laminated plate disposed on a side close to the first surface.

6. The light source apparatus according to claim 1, further comprising
a support member configured to support the second surface,
wherein thermal conductivity of the support member is higher than thermal conductivity of the wavelength converter.

7. The light source apparatus according to claim 6, further comprising
a pressing member configured to press the wavelength converter against the support member.

8. The light source apparatus according to claim 1, further comprising
an angle converting member that the second light exiting via the third surface enters,
wherein the angle converting member has a light incident surface on which the second light is incident, and a light exiting surface via which the second light exits, and
a maximum exiting angle of the second light exiting via the light exiting surface is smaller than a maximum incident angle of the second light incident on the light incident surface.

9. The light source apparatus according to claim 1, wherein
an intensity of the second light exiting via the third surface is higher than the intensity of the second light exiting via the first surface.

10. A projector comprising:
the light source apparatus according to claim 1;
a light modulator configured to modulate light containing the second light output from the light source apparatus; and
a projection optical apparatus configured to project the light modulated by the light modulator.
